(19) United States
(12) Patent Application Publication
(10) Pub. No.: US 2011/0149590 A1
(43) Pub. Date: Jun. 23, 2011

(54) Linear light source

(75) Inventors: Koichi Kamei, Hyogo (JP); Minoru Shigoku, Hyogo (JP); Yoshihisa Yokokawa, Hyogo (JP); Yoshihiro Kanahashi, Hyogo (JP)

(73) Assignee: USHIO DENKI KABUSHIKI KAISHA, Tokyo (JP)

(21) Appl. No.: 12/926,918

(22) Filed: Dec. 17, 2010

(30) Foreign Application Priority Data
Dec. 18, 2009 (JP) 2009-287026
Sep. 29, 2010 (JP) 2010-218198

(51) Int. Cl. F21V 8/00

(52) U.S. Cl. 362/555

(57) ABSTRACT

A linear light source, in which an LED is arranged at an end portion of an approximately cylindrical light guiding member configured so that an upper portion, which has an approximately circular portion and which includes a light emitting face, a flat lower portion, which includes a light reflection face formed so as to face the upper portion, and side portions which connect the upper portion and the lower portion to each other, are arranged to extend in a longitudinal direction, respectively, and a light diffusion and reflection member provided outside of the light guiding member.

### CROSS-REFERENCES TO RELATED APPLICATION

This application claims priority from Japanese Patent Application Serial No. 2009-287026 filed Dec. 18, 2009 and Japanese Patent Application Serial No. 2010-218198 filed Sep. 29, 2010, the contents of which are incorporated herein by reference in their entirety.

### TECHNICAL FIELD

The present invention relates to a linear light source used for a document lighting apparatus. Especially, the present invention relates to a linear light source has an LED (s) arranged at an end portion of a light guide member.

### BACKGROUND

Technology, in which a light emitting diode (LED) is used as a light source of a document lighting apparatus, is known. This technology is divided into two types, that is, an array type in which two or more LEDs are arranged over the entire document face in a width direction, and a light guide member type in which an LED is arranged at an end portion of a light guiding member made of a transparent resin, to propagate radiation light of the LED in the light guiding member. Recently, since an output of such an LED is becoming high, the light guiding member type attracts attention.

A linear light source using such a light guiding member is known, as disclosed, for example, in Japanese Patent No. 2900799. The patent discloses a structure in which an LED is arranged at an end portion of the light guiding member, radiation light from the LED enters the light guiding member so as to propagate inside the light guiding member, and furthermore, light that is reflected and diffused at a light diffusing unit, which is formed in the light guiding member, is emitted to a document face side.

FIG. 8 shows a structure of a linear light source of prior art. A linear light source 70 has an approximately cylindrical light guiding member 71 and LED light sources 72, which are respectively arranged at the respective end portions 73 in a longitudinal direction of this light guiding member 71. Radiation light from each LED light source 72 enters the light guiding member 71 from the end portions 73. The light, which enters the light guiding member 71, is emitted from a light emitting face 75, which faces a reflection groove 74, while repeating entire reflection in an axial direction by the reflection groove 74, which is made up of a concave and convex portion formed along the axial direction of the light guiding member 71.

In the case of such a linear light source installed in a copying machine, it is arranged at an angle with respect to a document reading area. This is because there is a structural limitation, that is, to capture light reflected from the document in CCDs, for example, in case of a contact exposure type machine, a Selfoc lens is arranged right under a document reading area, and in a reduction exposure type machine, a folding mirror is arranged thereunder.

FIG. 7A shows a physical relationship of a linear light source 62 (hereinafter simply referred to as a “light source”), and a document arrangement glass (which is in general, a platen glass, and simply referred to as a “glass”). The light source 62 is arranged in the left hand side of the figure with respect to a position on the glass 61 (a position of a Y-axis shown in an imaginary line a), at which radiation light condenses. That is, a document face is irradiated with the radiation light of the light source 62 from an inclined direction. Moreover, a light diffusion and reflection face 63 is formed in the light source 62. Furthermore, a light receiving element 65 is formed on the glass 61 (small rectangle members). By moving this light receiving element 65 in a direction shown by arrows in the figure, an illuminance distribution on the glass 61 can be measured.

FIG. 7B shows an illuminance distribution measured by the light receiving elements 65. In this figure, a vertical axis shows a relative value of illuminance on the glass 61. Specifically, the figure shows the relative intensity (%) in a case where a value of illuminance at an intersection “a1” of an imaginary line “a” and the glass, is set to 100%. A horizontal axis shows a position (mm) in an X axial direction on the glass 61.

Here, the imaginary line “a” is set as a Y-axis, and an intersection of the imaginary line “a” in a side of a document is set to an original point of an X-axis (O), wherein the light receiving element 65 is moved in both directions of “+X” (right side direction in the figure) and “−X” (left side direction in the figure) from the original point on the glass 61, and the relative intensity (%) of the light emitted toward the glass side was measured (black dot marks of this figure). Moreover, the light receiving element 65 is lifted by 1 mm in the Y axial direction, and in a similar way, the relative intensity (%) of the light in the direction X was measured at the point “a2” of the imaginary line “a” (“x” marks of this figure). In addition, similarly to the above-mentioned case, the figure shows the relative intensity (%) in this case, wherein a value of illuminance of light (an original point shows a black dot mark) at the intersection “a1” of the imaginary line “a” in the document side of the glass 61 is set as 100%.

As shown in FIG. 7B, the relative intensity (%) in each measurement point was measured, wherein when a position of the light receiving element 65 shown in FIG. 7A is 0 mm in the Y axial direction, and also is 0 mm in a direction X, a value of the illuminance thereof is set to 100%. In this example, at the negative side of the X axis, the relative intensity increases to −2.5 mm, wherein X=−2.5 mm is a peak, and after that, the relative intensity decreases from the peak. Moreover, the relative intensity gradually decreases in the positive side of the X axis from the original point, as a distance from the original point increases.

In FIG. 7B, X marks show data at time of Y=1 mm of FIG. 7A. A value of illuminance at a black dot mark X=0 mm, also serves as a reference, and data of each X mark shows data of relative intensity based on the reference value. In this case, it is peaked at −1.5 of the X axis (peak value), and the peak value of the relative intensity falls by approximately 10%, compared with a peak value in the case of black dot marks. Moreover, the relative intensity changes by approximately 40% in a range of ±1 mm in the X axial direction from the original point. Thus, since an illuminance distribution greatly differs depending on the position in the direction X or in the direction Y, there is a problem that an accurate copying cannot be performed in a document reading area.

In other words, since there are great differences of the values of illuminance in the direction Y (referred to as in a depth direction) of the document read area in the glass, on which the document is arranged, there is a problem that the contrast of the copied image is changed by the height (position or distance), at which the document is arranged so that the accurate copy cannot be made.

### SUMMARY

A linear light source, comprising an LED is arranged at an end portion of an approximately cylindrical light guiding member, wherein the light guiding member is configured so that an upper portion, which has an approximately circular portion and which includes a light emitting face, a flat lower portion, which includes alight reflection face formed to face the upper portion, and side portions which connect the upper portion and the lower portion to each other, are arranged to extend in a longitudinal direction, respectively, and wherein a light diffusion and reflection member is entirely provided outside of the light guiding member over at least one of the lower and side portions through an air layer.

The light diffusion and reflection member may be made from a white diffusion sheet or a translucent diffusion sheet and a mirror surface reflection member that is arranged on a back face of the white diffusion sheet.

Further, the light diffusion and reflection member may be made from a translucent diffusion sheet and a white diffusion sheet that is arranged on the back face of the diffusion sheet.

Furthermore, the light diffusion and reflection member may have a directional reflective surface.

### BRIEF DESCRIPTION OF THE DRAWINGS

Other features and advantages of the present linear light source will be apparent from the ensuing description, taken in conjunction with the accompanying drawings, in which:

FIG. 1A is a schematic cross sectional view of a linear light source according to a first embodiment of the present invention, taken in an optical axis direction;

FIG. 1B shows an illuminance distribution thereof;

FIG. 2A is a schematic structure of a linear light source according to a first embodiment of the present invention, wherein the linear light source is arranged in a document lighting apparatus;

FIGS. 2B and 2C show an illuminance distribution on a document arrangement glass, respectively;

FIG. 3A is a schematic cross sectional view of a linear light source according to a second embodiment of the present invention;

FIG. 3B shows an illuminance distribution in an optical axis direction;

FIG. 4A is a schematic structure of a linear light source according to a second embodiment of the present invention, wherein the linear light source is arranged on a document lighting apparatus;

FIGS. 4B and 4C show an illuminance distribution on a document arrangement glass, respectively;

FIGS. 5A-5E are schematic cross sectional views of a linear light source according to other embodiments of the present invention;

FIGS. 6A-6C are diagrams showing a linear light source according to the present invention, respectively;

FIGS. 6A1-6C1 respectively show distribution of light, which is emitted from a linear light source;

FIG. 7A is a diagram of an example of a document lighting apparatus, on which a linear light source of prior art is provided;

FIG. 7B shows an illuminance distribution based on difference in depth on a document face; and

FIG. 8 is a schematic perspective view of a linear light source of prior art.

### DESCRIPTION

It is an object of the present invention to offer a linear light source, which can realize a document read apparatus, in which there is little illuminance differences in a depth direction with respect to a document arrangement glass, which serves as a document reading face, and in which even if the height (position or distance) of the document that serves as an object to be read is different, the differences of the light intensities that enter the image taking elements, such as CCDs, are small, and there is no big difference between the contrast of a copied image and the original document.

A linear light source according to the present invention has a structure, in which an LED is arranged at an end portion of an approximately cylindrical light guiding member. The light guiding member is configured so that an upper portion, which has an approximately circular portion and which includes a light emitting face, a flat lower portion, which includes a light reflection face formed to face the upper portion, and side portions, which connect the upper portion and the lower portion to each other, are arranged to extend in a longitudinal direction, respectively, wherein a light diffusion and reflection member is entirely provided in an outside of the light guiding member over at least one of the lower and side portions thereof through an air layer.

Moreover, the light diffusion and reflection member may be made up of a white diffusion sheet.

Furthermore, the light diffusion and reflection member can also be made up of a translucent diffusion sheet and a mirror surface reflection member, which is arranged on a back face of the white diffusion sheet.

Moreover, the light diffusion and reflection member can also be made up of a translucent diffusion sheet and a white diffusion sheet, which is arranged on a back face of the diffusion sheet.

Furthermore, the light diffusion and reflection member may have a directional reflective surface. By using a linear light source according to the present invention, it is possible to accurately make a copy of a document without change in a illuminance of light with which a document face is irradiated, depending on the distance to the document face, since a light diffusion and reflection member is entirely provided over a light guiding member in a longitudinal direction. Moreover, since an air layer is inserted between the light diffusion and reflection member and the light guiding member, it is possible to improve a diffusion effect of the light, which is emitted from the light guiding member, so that even if the distance (height) to the document face changes, it is possible to make a clear copy of the document.

Moreover, according to a structure of the present invention, since the white diffusion sheet is used as the light diffusion and reflection member, a high reflection ratio can be secured so that diffused light can enter the light guiding member without reducing illuminance. As a result, even if the height (position or distance) of the document is different, it is possible to make a clear copy of a document without influence due to illuminance reduction.

Moreover, since the light diffusion and reflection member is made up of the translucent diffusion sheet and the mirror surface reflection member, which is arranged on the back face of the diffusion sheet, part of the diffused light passes therethrough in a state where light, which comes out of the light guiding member, is diffused, and enters the mirror surface reflection member, so that distribution of the light in the optical axis direction of the light guiding member is uniformized. Therefore, contrast of the light with which the document face is irradiated, is also low in the optical axis direction of the light guiding member, so that it is possible to irradiate the document with the uniformized light.

Furthermore, since the light diffusion and reflection member may be made up of a translucent diffusion sheet and a white diffusion sheet, which is arranged on a back face of the diffusion sheet, part of the diffused light passes therethrough in a state where light, which comes out of the light guiding member, is diffused, and further diffused by the white diffusion sheet to be reflected towards the light guiding member side. Thereby, contrast of the light with which the document face is irradiated, is also low in the optical axis direction of the light guiding member, so that it is possible to irradiate the document with the uniformized light.

Moreover, since, in addition to the above mentioned structure, the reflective surface having a directivity is formed under at least one of sides thereof through an air layer formed between the light guiding member and the reflection surface, the light which is emitted from the light guiding member, can be formed to be diffused light having distribution in a shifting direction from a central axis of the light guiding member. The present invention has an advantage that even if the height (position or distance) of the document varies, the illuminance distribution on the glass can be made flat, so that the difference of relative intensity of illuminance decreases, whereby it is possible to make a clear copy of the document.

A linear light source according to the present invention is configured so that an upper portion, which has an approximately cylindrical portion and which includes a light emitting face, for emitting light to a document face side, a lower portion, which is arranged to face the upper portion and which includes a reflective face having a shape of a prism made up of a concave and convex portion, are connected by side portions. Moreover, a light diffusion and reflection member is provided on the lower portion of a light guiding member and at least one of the side portions, through an air layer. It is possible to make a deviation in illuminance distribution in across sectional direction of the light guiding member by this light diffusion reflection member. As a result, even if the height (position or distance) of a document varies, there is an advantage that illuminance change on the document face can be reduced.

According to this structure, by passing light through the prism-like reflective surface, and by diffusing and reflecting the light, which leaks to the outside of the light guiding member, the spread of light in a cross section taken at an optical axis can be smoothened. For this reason, even if the document face shifts from a contact glass (the height changes), almost uniform light can be emitted. Moreover, there is also an advantage that copying can be accurately performed without forming the shading (contrast density) due to the intensity of the light with which the document face to be copied is irradiated.

### First Embodiment

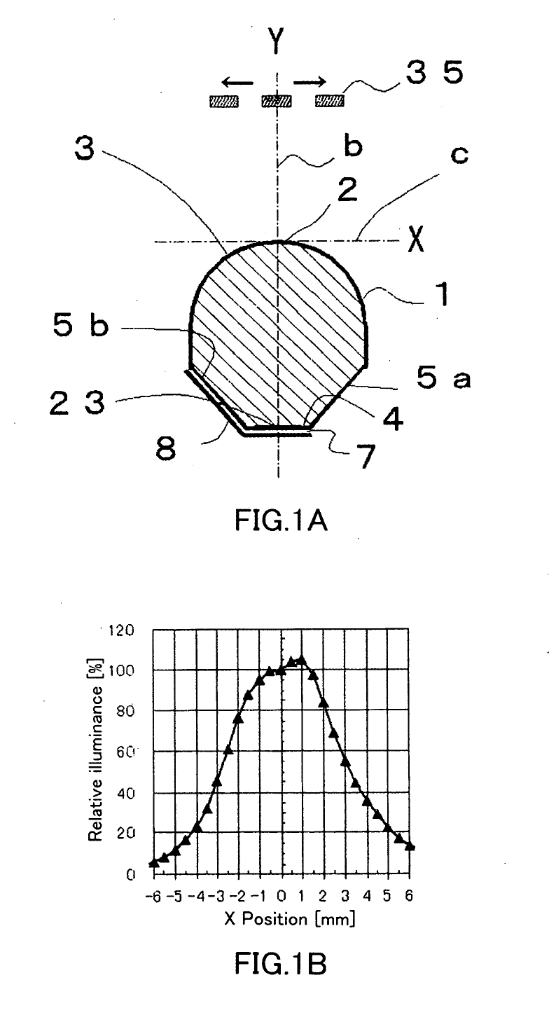

FIG. 1A is a linear light source according to a first embodiment of the present invention. Specifically, FIG. 1A is a cross sectional view of a light guiding member 1, taken perpendicularly to an axis direction of a light guiding member 1. The light guiding member 1 comprises an upper portion 3 including a light emitting face 2, a lower portion 4, which is arranged to face the upper portion 3, and side portions 5a and 5b, which connect the upper portion 3 and the lower portion 4 to each other. Moreover, a light reflection face 23, which is in shape of prism made up of a concave and convex portion, is formed in the lower portion 4 to face the upper portion 3.

A light diffusion and reflection member 8 is provided in an outside of the lower portion 4 and the side portion 5b, through an air layer 7. The light guiding member 1 is not tightly brought in contact with the light diffusion and reflection member 8, so that there is a very small gap therebetween. Moreover, the light diffusion and reflection member 8 is made up of, for example, a white diffusion sheet. Specifically, the white diffusion sheet, which is made of polyethylene terephthalate (PET resin), which is mixed with microscopic particles of titanium dioxide (for example, LUMIRROR E6QD, manufactured by TORAY INDUSTRIES, INC.), is used. In this figure, an imaginary line b, which connects the center of the light guiding member 1 and the center of the reflective surface 23 to each other, is on a Y axis, and an imaginary line c, which passes through an intersection of the upper portion 3 and the imaginary line b and which intersects the imaginary line b at right angle, is on an X axis. An illuminance distribution was measured by moving the light receiving element 35 in directions of arrows shown in the figure. The result is shown in FIG. 1B.

FIG. 1B shows a graph in which a position on the X axis is on a horizontal axis, and a relative illuminance (%) is on a vertical axis, providing that illuminance at the origin of the X axis (illuminance of light, which is emitted to a front of the light guiding member), is 100%.

Since the light diffusion and reflection member 8 is arranged under the lower portion 4 and the side portion 5b, a peak position of relative illuminance is shifted to a right hand side from the position of X=0 mm.

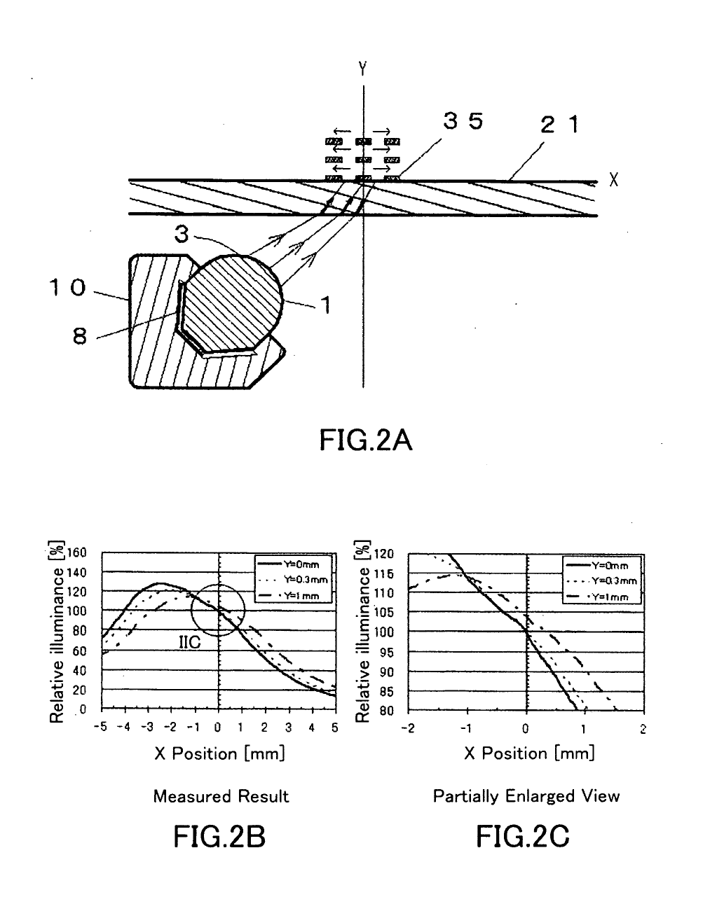

FIG. 2A is a schematic diagram of a document lighting apparatus using the light guiding member 1 shown in FIG. 1A. The light guiding member 1 is held by a support member 10. The light, which is emitted from the upper portion 3 of the light guiding member 1, is condensed on a glass 21. Furthermore, a light receiving element 35 is arranged on the glass 21 to receive light emitted from the light guiding member 1.

Moreover, FIG. 2B shows an illuminance distribution on the glass 21. Specifically, FIG. 2B shows an illuminance distribution in each position in an X axial direction when changing a position of the Y axis, wherein a face, on which a document is arranged, is represented as an X axis, and an imaginary line passing through a point, at which the light emitted from the light guiding member 1 is condensed, and intersecting with the x axis at right angle, is represented as a Y axis. Moreover, FIG. 2C is an enlarged view of a circle portion IIC around the position X=0 of FIG. 2B. In this figure, a solid line shows an illuminance distribution on the glass 21 (Y=0 mm). Moreover, a dotted line shows an illuminance distribution in a case where a document surface is away from the glass 21 by 0.3 mm, and a dotted-dash line shows an illuminance distribution in a case where the document surface is away from the glass 21 by 1 mm, respectively.

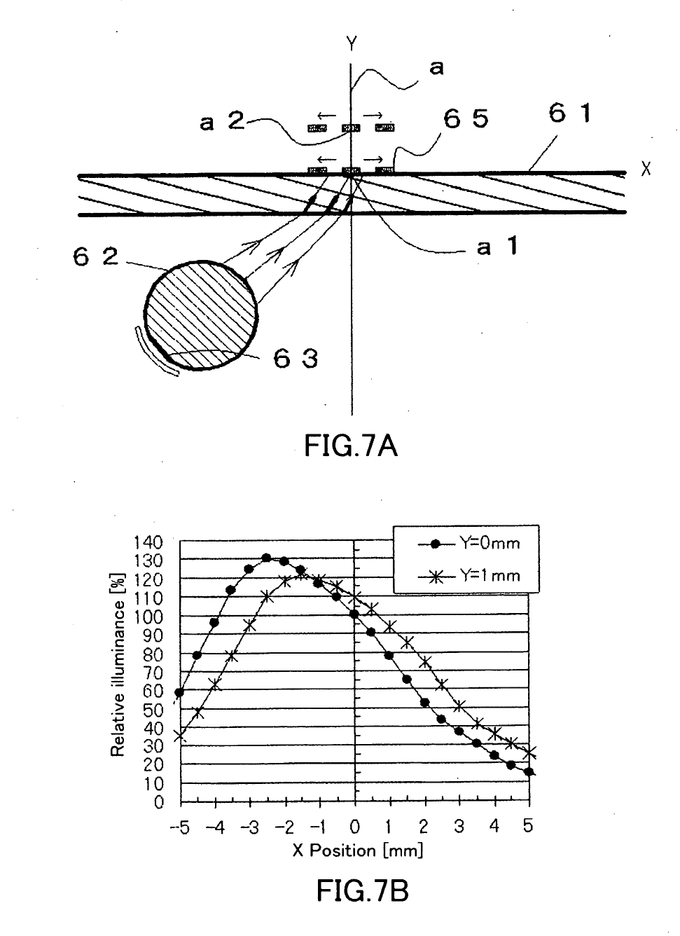

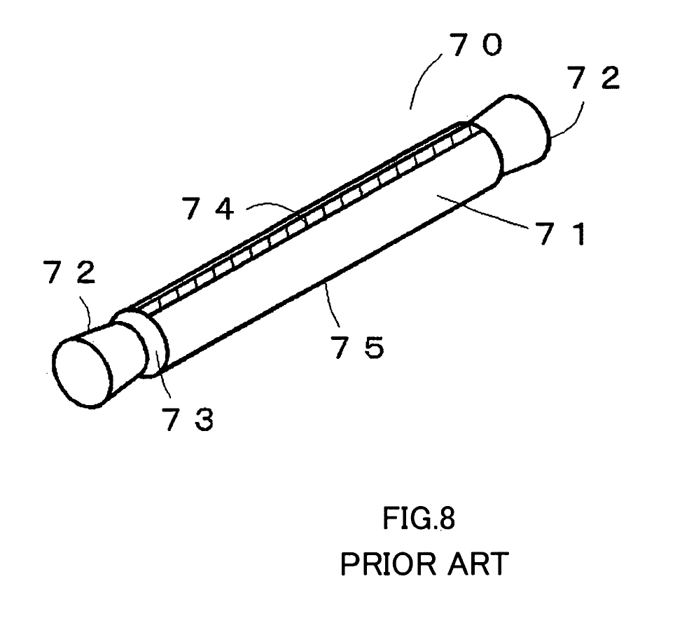

According to FIGS. 2B and 2C, the difference between relative intensity of illuminance at Y=0 mm and that at Y=1 mm, is approximately 4% at X=0 mm, which is smaller than that of the prior art (illuminance difference at X=0 mm shown in FIG. 7B is approximately 10%). Moreover, as to a position of X=±1 mm, the relative intensity at X=−1 mm is approximately 3%, and that at X=+1 mm is approximately 10%, which is smaller than that of the prior art. Thus, since the light diffusion and reflection member 8 is provided under the lower portion 4 and the side portion 5b of the light guiding member 1, a peak value of the distribution of light, which is emitted from the light guiding member 1, can be shifted from a center. Thereby, the distribution of light on the glass 21 can be made flat. Even if a document is arranged so as to be away from the glass 21, it is possible to emit light whose intensity change is small, whereby there is an advantage that it is possible to make a clear copy of the document.

### Second Embodiment

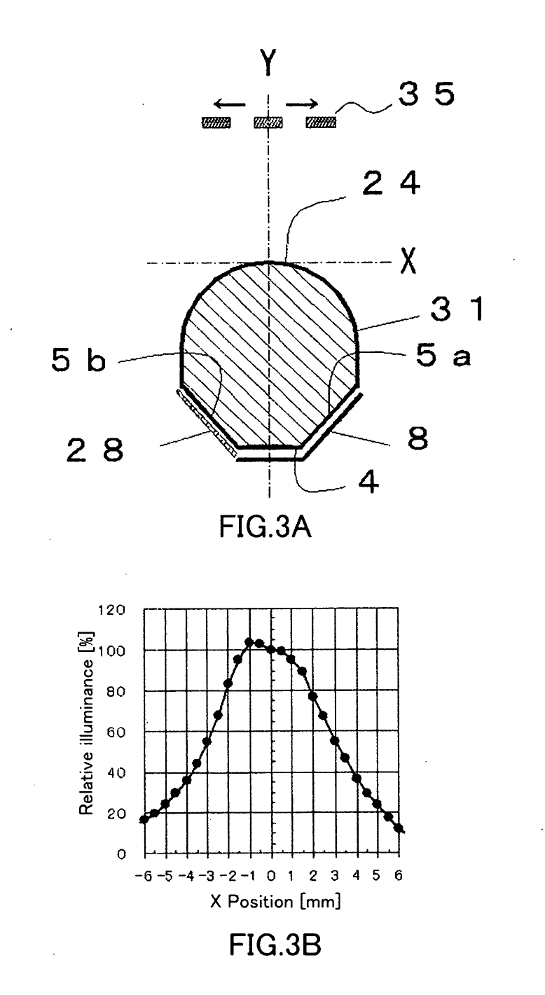

FIGS. 3A and 3B show a second embodiment according to the present invention. FIG. 3A shows a structure of a light guiding member 31, which is similar to that shown in the first embodiment. However, a position of a light diffusion and reflection member 8 is different. Specifically, the light diffusion and reflection member 8 is arranged under a lower portion 4 and a side portion 5a of the light guiding member 1. In addition, another light diffusion and reflection member 28, which has directivity with comparatively large mirror reflection components, is provided on a side section 5b. In the present embodiment, for example, LUMIRROR E6SV, manufactured by TORAY INDUSTRIES, INC. is used as the light diffusion and reflection member 28 having such directivity. Moreover, a white diffusion sheet made of polyethylene terephthalate (PET resin), which is mixed with microscopic particles of a titanium dioxide (for example, LUMIRROR E6QD, manufactured by TORAY INDUSTRIES, INC.) is used, for the light diffusion and reflection member 8. FIG. 3B shows an illuminance distribution of light, which is emitted from a light emitting face 24 of such a light guiding member 31. Similarly to FIG. 1B, FIG. 3B shows a graph, in which a position on the X axis is on a horizontal axis, and a relative illuminance (%) is on a vertical axis, providing that illuminance at the origin of the x axis (illuminance of light, which is emitted to a front of the light guiding member), is 100%. Since the light diffusion and reflection member 8, which is provided at the light guiding member 31, is arranged only under the lower portion 4 and the side portion 5a, and the side portion 5b has another light diffusion and reflection member 28, a peak position of relative illuminance is shifted to a left hand side from the position X=0 mm, contrary to the case shown in FIG. 1B.

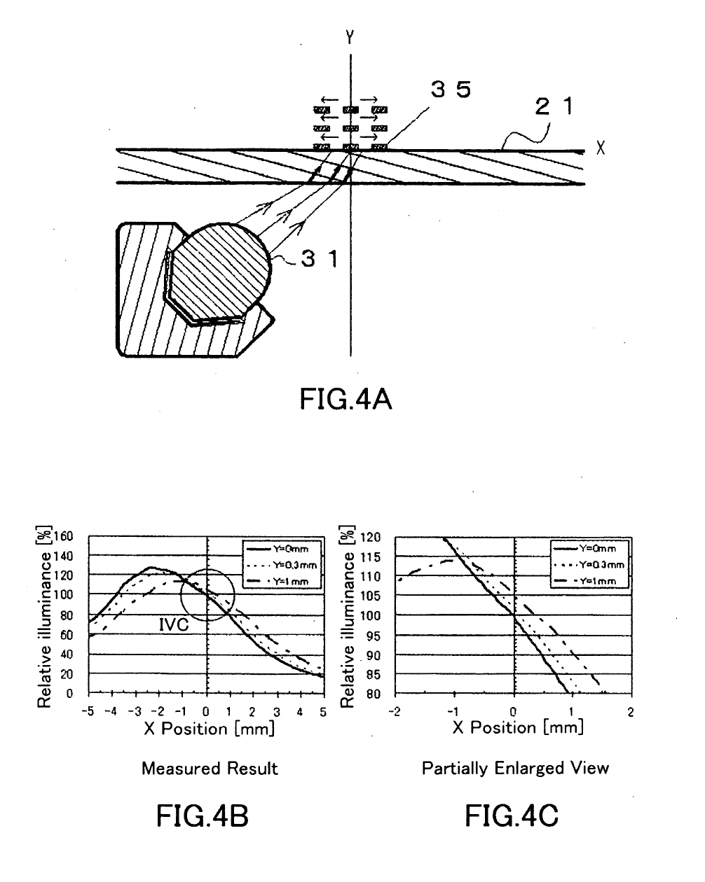

Similarly to FIG. 2A, FIG. 4A is a schematic cross sectional view in a case where a light guiding member 31 is arranged in a document lighting apparatus. FIGS. 4B and 4C show an illuminance distribution on a glass 21 in the document lighting apparatus. Both FIGS. 4B and 4C are graphs, in each of which a relative intensity (%) of illuminance is on a vertical axis, and a position of measured illuminance on the X axis of the glass 21 is on a horizontal axis. FIG. 4C is an enlarged view of a circle portion IVC of FIG. 4B.

In FIG. 4B or 4C, the difference between illuminance of relative intensity at Y=0 mm and that at Y=1 mm, is approximately 5% when X=0 mm, which is smaller than that of the prior art. Moreover, as to a position of X=±1 mm, the relative intensity at X=−1 mm is less than 1%, and that at X=+1 mm is approximately 10%, which is smaller than that of the prior art. Thus, a light diffusion and reflection member 8 is provided each under a lower portion 4 and a side portion 5a of the light guiding member 31, and it is further provided under a side portion 5a, so that a peak value of the distribution of light, which is emitted from the light guiding member 31, can be shifted from a center, whereby the illuminance distribution on the glass 21 can be made flat. Even if a document is arranged to be away from the glass 21, it is possible to emit light whose intensity change is small, whereby there is an advantage that it is possible to make a clear copy of the document. In addition, although a document lighting apparatus having one guiding member is described in the present embodiment, if a second light guiding member is arranged in a target position on opposite side with respect to a Y axis, the illuminance becomes higher, so that it is possible to emit light whose intensity change is small, even if the height of a document varies.

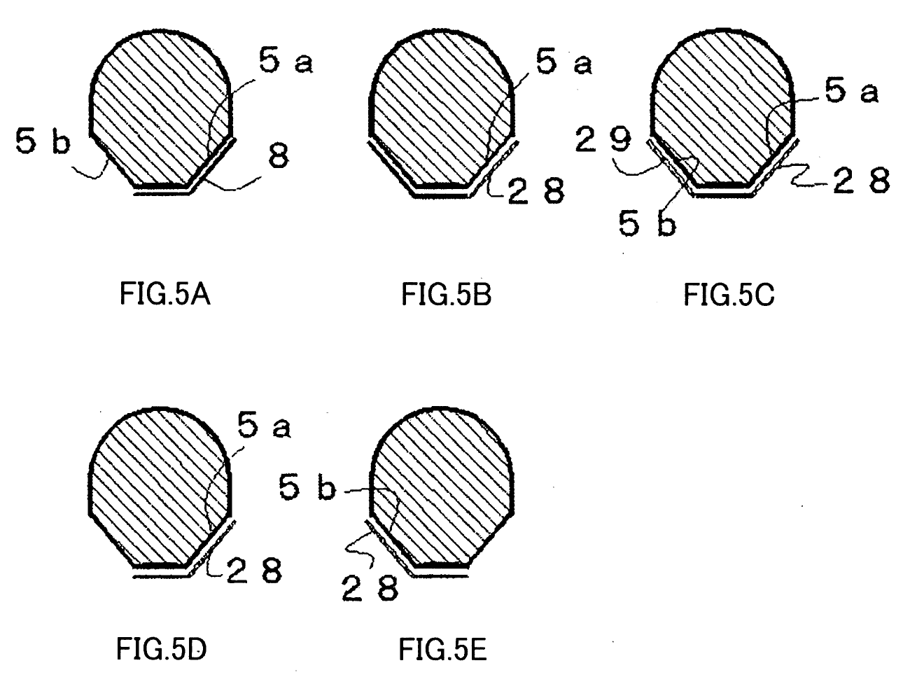

FIGS. 5A through 5E show other embodiments of a light guiding member according to the present invention. The light guiding member 1 shown in FIG. 5A is different from that shown in FIG. 1A, in view of a direction of a light diffusion and reflection face 8, which is provided on a side portion 5b. In this embodiment, there is no light diffusion and reflection face 8 under the side of the side portion 5b, and the light diffusion and reflection face 8 is provided under a side of a side portion 5a. According to this structure, an illuminance distribution, which is reversed from that of FIG. 1A, can be realized.

Alight guiding member shown in FIG. 5B has a light diffusion and reflection face 28 with directivity under a side of the side portion 5a, in addition to the structure of the light guiding member 1 shown in FIG. 1A. By adjusting the directivity of the light diffusion and reflection face 28, an illuminance distribution suitable for a document lighting apparatus can be offered.

Alight guiding member shown in FIG. 5C has a light diffusion and reflection face 8 under a lower portion of the light guiding member 1, and light diffusion and reflection faces 28 and 29, which have directivity, respectively, are arranged under the both side portions 5a and 5b, which are adjacent to each other on the lower portion. The directivities of the light diffusion reflection faces 28 and 29 are different from each other so that the illuminance distribution can be biased in a fixed direction.

A light guiding member shown in FIG. 5D is different from that of FIG. 5A in that a light diffusion and reflection face 28, which has a light diffusion and reflection face with directivity is provided under the side portion 5a of the light guiding member.

In a light guiding member shown in FIG. 5E, a light diffusion and reflection face, which is arranged under the side portion 5a in FIG. 5D, is arranged under a side portion 5b. Thus, there is an advantage that the illuminance distribution can be appropriately changed, depending on the positions and characteristics of the light diffusion and reflection face(s) that are arranged under the light guiding member.

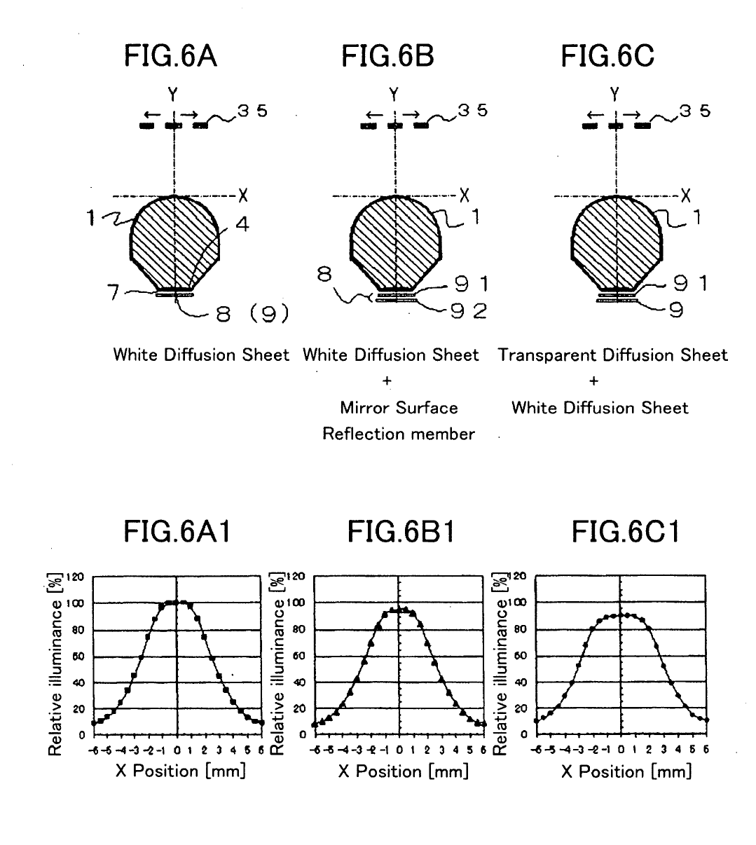

FIGS. 6A-6C and 6A1-6C1 show embodiments according to the present invention, wherein a light diffusion and reflection face 8 is variously changed. FIG. 6A is an example in which, a white diffusion sheet 9 made of polyethylene terephthalate (PET resin), with which microscopic particles of a titanium dioxide, is formed on a light diffusion and reflection face 8 and is arranged under a side of a lower portion 4 through an air layer 7. Since the light diffusion and reflection face 8 is formed of such a white diffusion sheet, there is an advantage that a high reflection ratio can be secured while securing a diffusion function. Moreover, FIGS. 6A1-6C1 show an illuminance distribution of the light emitted from a light guiding member 1, respectively. FIG. 6A1 shows an illuminance distribution in the case where the white diffusion sheet 9 is provided as the light diffusion reflection face 8 only on the lower portion 4, in which a relative intensity (%) is shown in the case where illuminance in a front side direction is set to 100%. The illuminance distribution in a front side direction, in which the illuminance is high, has a gentle slope in a wide range. When, in the light guiding member 1 having such distribution, the light diffusion and reflection face 8 is provided to one side portion 5a or the other side portion 5b, it is possible to irradiate the document with uniform light on a document arrangement glass so that even if the distance (height) to the document face changes, which an advantage of making a clear copy of the document.

FIG. 6B shows a case where a translucent sheet 91 is provided instead of the white diffusion sheet 9 shown in FIG. 6A, and a mirror surface reflection member 92 is provided on a back face of the translucent sheet 91. Moreover, FIG. 6B1 shows an illuminance distribution of light emitted from the light guiding member 1, wherein the relative intensity (%) is shown in the case where the illuminance in a front face of the light guiding member 1 of FIG. 6A is set as a reference value. Illuminance distribution shown in FIG. 6B1 is different from that shown in FIG. 6A1, that is, the illuminance distribution at the front face is slightly lower than that of FIG. 6A1, although the light spread is approximately the same as that of FIG. 6A1, and the illuminance distribution has a gentle slope in a wide range. When, in the light guiding member 1 having such distribution, the light diffusion and reflection face 8 is provided under one side portion 5a or the other side portion 5b, it is possible to irradiate the document with the uniform light on a document arrangement glass so that even if the distance (height) to the document face changes, which provides an advantage of making a clear copy of the document. Furthermore, in such a structure, the distribution of light in an optical axis direction, which is a longitudinal direction of the light guiding member 1, is uniformized. Therefore, the light contrast, with which the document face is irradiated, is also low in the optical axis direction of the light guiding member, producing the further advantage of irradiating the document with the uniform light.

FIG. 6C shows a case where, in addition to the white diffusion sheet 9 shown in FIG. 6A, a translucent diffusion sheet 91 shown in FIG. 6B is provided between a light guiding member 1 and the white diffusion sheet 9. As the translucent sheet, for example, 25 MBC, manufactured by KIMOTO, Co Ltd. can be used. FIG. 6C1 shows an illuminance distribution of light emitted from the light guiding member 1, wherein the relative intensity (%) is shown in case where the illuminance in a front face of the light guiding member 1 shown in FIG. 6A is set as a reference value. The illuminance distribution shown in FIG. 6C1 is different from those of FIGS. 6A1 and 6B1, in that the illuminance in the front face direction is lower than those of FIGS. 6A1 and 6B1, and the spread of light becomes very wide. Since the illuminance distribution has a gentle slope in a wide range, when the light diffusion and reflection face 8 is provided under one side portion 5a or the other side portion 5b of the light guiding member 1 to form such a distribution, it is possible to irradiate the document with the uniform light on a document arrangement glass so that even if the distance (height) to the document face changes, there is the advantage of making a clear copy of the document. Furthermore, contrast of the light, with which the document face is irradiated, is also low in the optical axis direction of the light guiding member 1, so that there is an advantage of irradiating the document with more uniform light.

The preceding description has been presented only to illustrate and describe exemplary embodiments of the present linear light source. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A linear light source, comprising:
an LED is arranged at an end portion of an approximately cylindrical light guiding member, wherein the light guiding member is configured so that
an upper portion, which has an approximately circular portion and which includes a light emitting face,
a flat lower portion, which includes a light reflection face formed to face the upper portion, and
side portions which connect the upper portion and the lower portion to each other, are arranged to extend in a longitudinal direction, respectively, and
wherein a light diffusion and reflection member is entirely provided outside of the light guiding member over at least one of the lower and side portions through an air layer.

2. The linear light source light according to claim 1, wherein the light diffusion and reflection member is made from a white diffusion sheet.

3. The linear light source light according to claim 1, wherein the light diffusion and reflection member is made from a translucent diffusion sheet and a mirror surface reflection member, which is arranged on a back face of the white diffusion sheet.

4. The linear light source according to claim 1, wherein the light diffusion and reflection member is made from a translucent diffusion sheet and a white diffusion sheet that is arranged on the back face of the diffusion sheet.

5. The linear light source light according to claim 1, wherein the light diffusion and reflection member has a directional reflective surface.
